(19) United States
(12) Patent Application Publication
(10) Pub. No.: US 2006/0002406 A1
(43) Pub. Date: Jan. 5, 2006

(54) Network connection apparatus, program, and method

(76) Inventors: Takeshi Ishihara, Kanagawa-Ken (JP); Akira Ichie, Saitama-Ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/170,303

(22) Filed: Jun. 30, 2005

(30) Foreign Application Priority Data
Jul. 1, 2004 (JP) 2004-195617

(51) Int. Cl. H04L 12/28

(52) U.S. Cl. 370/401

(57) ABSTRACT

There is provided a network connection apparatus comprising: a request acceptance unit which accepts a assignment request of network identification information from a different network connection apparatus connected to the network; an assigning unit which assigns the network identification information to the different network connection apparatus; a noticing unit which notifies the different network connection apparatus of the assigned network identification information; a generating unit which generates routing information on the basis of the assigned network identification information and host identification information of the different network connection apparatus; and a transmitting unit which transmits the generated routing information to a further different network connection apparatus other than the different network connection apparatus, connected to at least one of the networks.

### CROSS-REFERENCE TO RELATED APPLICATIONS

This application claims the benefit of priority under 35USC § 119 to Japanese Patent Application No. 2004-195617 filed on Jul. 1, 2004, the entire contents of which are incorporated herein by reference.

### BACKGROUND OF THE INVENTION

1. Field of the Invention

The present invention relates to a network connection apparatus for connecting a plurality of networks to each other, a program, and a method for distributing routing information.

2. Related Art

In order to connect a plurality of networks to each other and conduct communication between those networks, it is necessary to suitably assign network identification information to -respective networks and suitably set routing information in network connection apparatuses (routers) which interconnect networks. In the IPv6, a prefix can be automatically distributed by using prefix delegation. However, routing setting of each router is conducted independently of the prefix delegation. Therefore, routing information in each router must be suitably managed by manual setting of routing information conducted by the manager and use of a routing control protocol.

As for this problem, there is description concerning simultaneous execution of hierarchical prefix delegation and routing control in the “Hierarchical Prefix Delegation Protocol for Internet Protocol Version 6 (IPv6)”, Byung-Yeob Kim, Kyeong-Jin Lee, Jung-Soo Park, Hyoung-Jun Kim, February 2004, internet-draft, draft-bykim-ipv6-hpd-01.txt. However, details are not mentioned therein. Furthermore, a problem that optimum routing information cannot be exchanged among a plurality of routers placed at the same level is left.

### SUMMARY OF THE INVENTION

According to an aspect of the present invention, there is provided a network connection apparatus which connects a plurality of networks to each other and conducts data transfer between the networks by using previously given routing information, the network connection apparatus comprising: a request acceptance unit which accepts a assignment request of network identification information from a different network connection apparatus connected to the network; an assigning unit which assigns the network identification information to the different network connection apparatus on the basis of the assignment request; a noticing unit which notifies the different network connection apparatus of the assigned network identification information; a generating unit which generates routing information on the basis of the assigned network identification information and host identification information of the different network connection apparatus; and a transmitting unit which transmits the generated routing information to a further different network connection apparatus other than the different network connection apparatus, connected to at least one of the networks.

According to an aspect of the present invention, there is provided a program for inducing an network connection apparatus that connects a plurality of networks to each other and conducts data transfer between the networks by using previously given routing information, to execute: accepting a assignment request of network identification information from a different network connection apparatus connected to the network; assigning the network identification information to the different network connection apparatus on the basis of the assignment request; notifying the different network connection apparatus of the assigned network identification information; generating routing information on the basis of the assigned network identification information and host identification information of the different network connection apparatus; and transmitting the generated routing information to a further different network connection apparatus other than the different network connection apparatus, connected to at least one of the networks.

According to an aspect of the present invention, there is provided a method of distributing routing information by a network connection apparatus that connects a plurality of networks to each other and conducts data transfer between the networks by using previously given routing information, comprising: accepting a assignment request of network identification information from a different network connection apparatus connected to the network; assigning the network identification information to the different network connection apparatus on the basis of the assignment request; notifying the different network connection apparatus of the assigned network identification information; generating routing information on the basis of the assigned network identification information and host identification information of the different network connection apparatus; and transmitting the generated routing information to a further different network connection apparatus other than the different network connection apparatus, connected to at least one of the networks.

### BRIEF DESCRIPTION OF THE DRAWINGS

FIG. 1 is a functional block diagram of a network connection apparatus according to a first embodiment of the present invention;

FIG. 2 is a diagram showing a configuration of a network system according to the first embodiment;

FIG. 3 is an assignment management table in a parent router immediately after a prefix is assigned to a child router in the first embodiment;

FIG. 4 is an assignment management table in a parent router immediately after a prefix is assigned to a child router in the first embodiment;

FIG. 5 is a diagram showing a state in which prefixes have been assigned to the network system shown in FIG. 2;

FIG. 6 is a network identification information table storing a prefix managed by a parent router in the first embodiment;

FIG. 7 is an assignment management table in a parent router immediately after a validity term of a prefix assigned to a child router has expired in the first embodiment;

FIG. 8 is a table showing a state in which an entry having a validity term that has expired is deleted from the assignment management table shown in FIG. 7;

FIG. 9 is a functional block diagram of a network connection apparatus according to a second embodiment of the present invention;

FIG. 10 is a routing notice control table referred to in order to execute notice restriction of routing information in the second embodiment;

FIG. 11 is a functional block diagram of a network connection apparatus according to a third embodiment of the present invention;

FIG. 12 is a diagram showing a configuration of a network system according to the third embodiment;

FIG. 13 is a routing table in the parent router in the third embodiment obtained after a prefix is assigned to a child router;

FIG. 14 is a routing table in a child router in the third embodiment obtained immediately after a prefix is assigned;

FIG. 15 is a routing table in a child router in the third embodiment obtained immediately after a prefix is assigned;

FIG. 16 is a routing table in a child router in the third embodiment obtained after processing on a routing alteration notice is conducted;

FIG. 17 is a routing table in a child router in the third embodiment obtained after processing on a routing alteration notice is conducted;

FIG. 18 is a diagram showing a processing sequence conducted by the network system shown in FIG. 5;

FIG. 19 is a flow chart showing a flow of whole processing conducted by the parent router in the first embodiment;

FIG. 20 is a flow chart showing prefix acquisition request processing conducted by the parent router in the first embodiment;

FIG. 21 is a flow chart showing routing information generation processing conducted by the parent router in the first embodiment;

FIG. 22 is a flow chart showing routing information update notice processing (first method) conducted by the parent router in the first embodiment;

FIG. 23 is a flow chart showing routing information update notice processing (second method) conducted by the parent router in the first embodiment;

FIG. 24 is a flow chart showing routing information update notice processing (third method) conducted by the parent router in the first embodiment;

FIG. 25 is a flow chart showing routing information update notice processing (fourth-first method) conducted by the parent router in the first embodiment;

FIG. 26 is a flow chart showing routing information update notice processing (fourth-second method) conducted by the parent router in the first embodiment;

FIG. 27 is a flow chart showing processing conducted by a child router (corresponding to the first method) in the first embodiment;

FIG. 28 is a flow chart showing processing conducted by a child router (corresponding to the second method) in the first embodiment;

FIG. 29 is a flow chart showing processing conducted by a child router (corresponding to the third method) in the first embodiment;

FIG. 30 is a flow chart showing processing conducted by a child router (corresponding to the fourth-first method) in the first embodiment;

FIG. 31 is a flow chart showing processing conducted by a child router (corresponding to the fourth-second method) in the first embodiment;

FIG. 32 is a flow chart showing legality verification processing conducted by a child router in the first embodiment;

FIG. 33 is a flow chart showing routing information acquisition request processing conducted by a parent router in the first embodiment;

FIG. 34 is a flow chart showing first notice control processing conducted by the parent router in a second embodiment;

FIG. 35 is a flow chart showing second notice control processing conducted by the parent router in the second embodiment;

FIG. 36 is a flow chart showing third notice control processing conducted by the parent router in the second embodiment; and

FIG. 37 is a diagram showing a processing sequence of a network system according to a third embodiment.

### DETAILED DESCRIPTION OF THE DRAWINGS

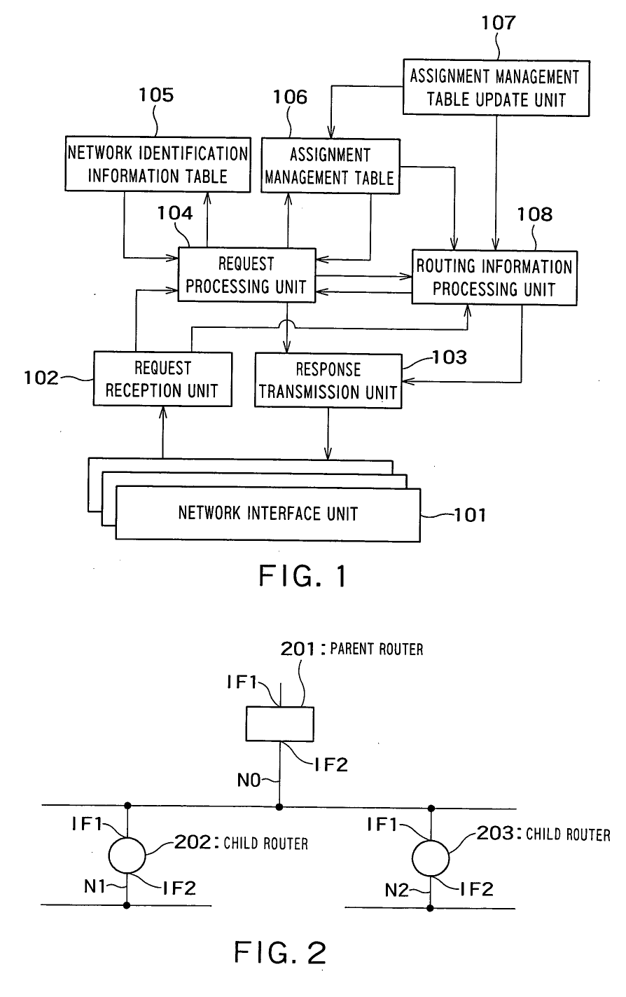

FIG. 1 is a configuration diagram of a network connection apparatus (router) in a first embodiment of the present invention.

In FIG. 1, reference numeral 101 denotes a network interface unit connected to a network. Numeral 102 denotes a request reception unit that receives a message from another network connection apparatus connected to the network and outputs the received message to an output destination depending upon contents of the message (network identification information acquisition request (prefix acquisition request) or routing information acquisition request). Numeral 103 denotes a response transmission unit that returns a message response (network identification information acquisition response (prefix acquisition response), routing information update notice or routing information notice) to another network connection apparatus connected to the network. Numeral 104 denotes a request processing unit which conducts processing on the prefix acquisition request received by the request reception unit 102. Numeral 105 denotes a network identification information table that stores network identification information (prefixes) that can be assigned by the network connection apparatus. Numeral 106 denotes an assignment management table that stores prefixes assigned by the request processing unit 104 in response to requests from another network connection apparatuses. Numeral 107 denotes an assignment management table update unit that periodically updates the assignment management table 106. Numeral 108 denotes a routing information processing unit that conducts processing on a routing information acquisition request received by the request reception unit 102.

FIG. 2 is a diagram showing a configuration of a network system according to the present embodiment.

In FIG. 2, a parent router 201 connects a plurality of subordinate networks N0 to N2 and child routers 202 and 203 which connect them to each other, to a router in an external ISP (Internet Service Provider). The child routers 202 and 203 are connected to the network N0 of the parent router 201. The child routers 202 and 203 have the networks N1 and N2 as subordinates, respectively. Each of the parent router 201, and the child routers 202 and 203 includes the components 101 to 108 shown in FIG. 1. In FIG. 2, IF1 denotes an upstream interface, and IF2 denotes a downstream interface.

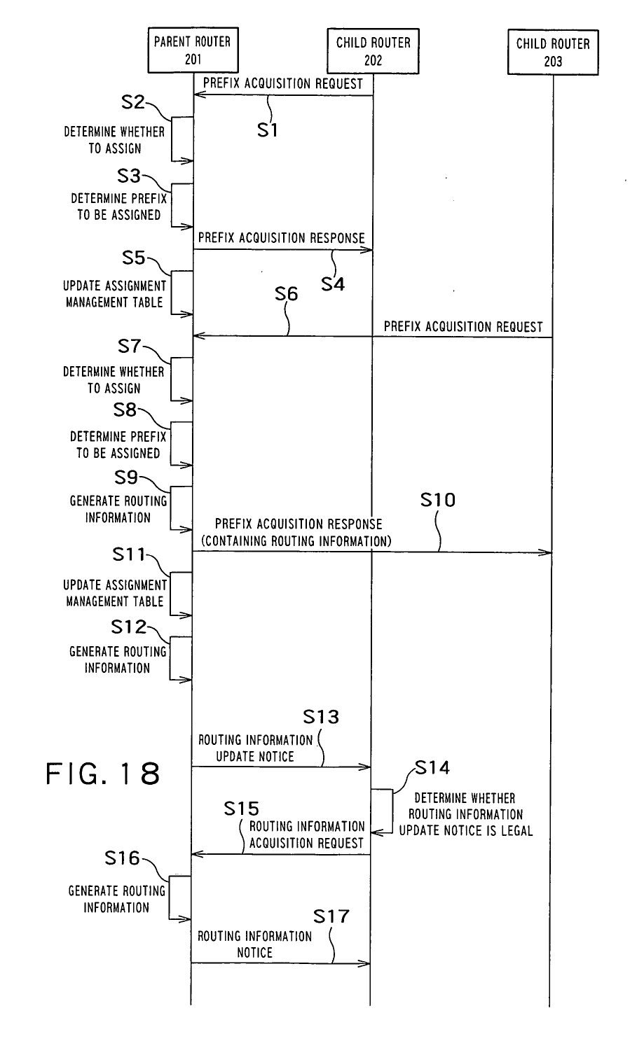

FIG. 18 is a sequence diagram showing operation of the network system shown in FIG. 2. In the ensuing description, the case where the IPv6 is used will be described for convenience. As for various terms as well, terms in the IPv6 will be used.

It is now supposed that the parent router 201 has already acquired prefixes that can be used in the subordinate networks N0 to N2 by using some technique such as the prefix delegation or manager's manual setting.

First, the state immediately after the child router 202 is connected to the network N0 of the parent router 201 will now be considered. At this time, the child router 202 searches the network N0 for a router that can execute prefix delegation, and the parent router 201 executes the prefix delegation between it and the child router 202. If in a series of procedures of the prefix delegation the request reception unit 102 in the parent router 201 receives a prefix acquisition request (step S1), the request is sent to the request processing unit 104.

The request processing unit 104 analyzes the received prefix acquisition request, and determines whether to accept or reject the request on the basis of the prefix state stored in the network identification information table 105 (step S2). When accepting the request, the request processing unit 104 determines a prefix to be assigned (step S3).

For particulars, the request processing unit 104 refers to the network identification information table 105 and the assignment management table 106 in order to whether the prefix requested in the request message can be assigned. First, the request processing unit 104 refers to the network identification information table 105 and determines whether the request message requests a prefix under its own management. If the request message requests a prefix that is not under the management at this time, the request processing unit 104 rejects the request, and returns a response to that effect via the response transmission unit 103. If the request message requests a prefix that is under the management, the request processing unit 104 refers to the assignment management table 106 to determine whether the requested range is already assigned. If the requested range is already assigned, the request processing unit 104 rejects the request and returns a response to that effect via the response transmission unit 103. If the requested prefix can be assigned, the request processing unit 104 accepts the request and returns a prefix acquisition response containing the prefix together with a validity term of the prefix via the response transmission unit 103 (step S4). If the child router 202 does not specify a specific prefix in the prefix acquisition request, the request processing unit 104 selects suitable one from prefixes that can be assigned, assign it, and returns a prefix acquisition response.

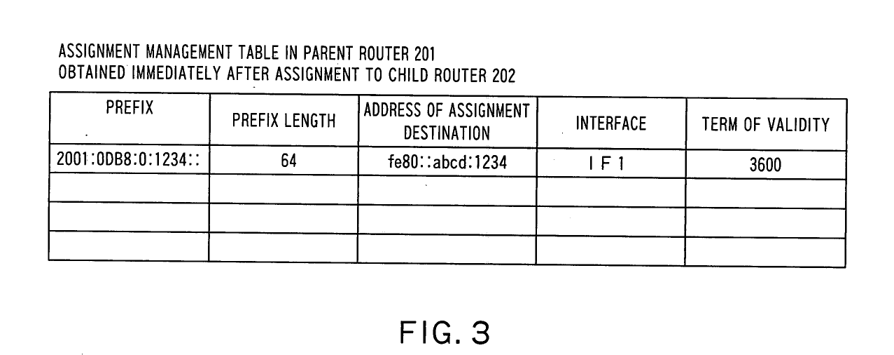

It is now supposed that a prefix “2001:0DB8:0:1234::/64” is assigned to the child node 202 with a validity term of 3600 seconds via the prefix assignment procedure heretofore described. It is now supposed in this case that an entry is added to the assignment management table 106 in the parent router 201 and an alteration is conducted as shown in FIG. 3 (step S5).

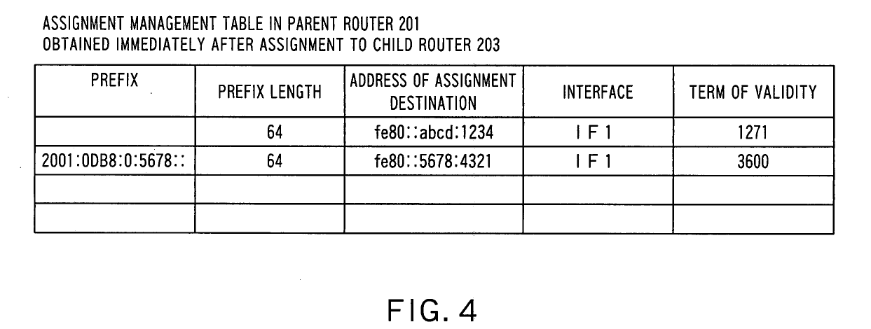

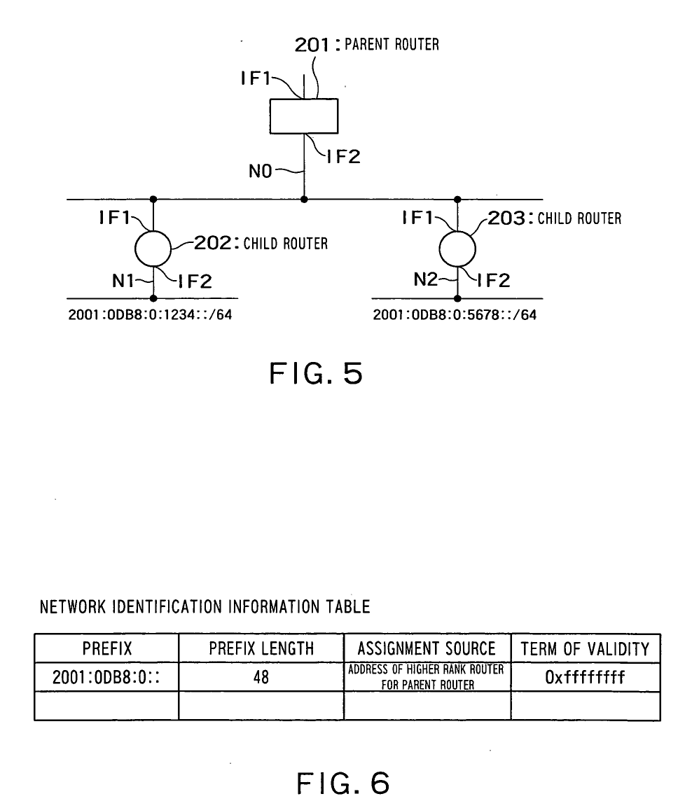

It is supposed that the child router 203 is connected to the network N0 of the parent router 201 in the wake of the child router 202. It is supposed that a prefix “2001:0DB8:0:5678::/64” is assigned to the child node 203 with a validity term of 3600 seconds substantially in the same way as the case of the child router 202 (steps S6 to S10) and the assignment management table 106 in the parent router 201 is updated as shown in FIG. 4 (step S11). (In FIG. 4, some time elapses from assignment to the child router 202, and consequently the value of the validity term decreases.) The state of the network system at the current time is shown in FIG. 5.

In the processing of assigning a prefix to the child router 203, however, new processing is added as compared with the processing of assigning a prefix to the child router 202 (step S9, see steps 512 to S17). This processing is broadly divided into the following three steps.

(1) The request processing unit 104 notifies the routing information processing unit 108 of the prefix assigned to the child router 203 and information concerning the child router 203 of assignment destination (step S9).

(2) The routing information processing unit 108 generates routing information to be contained in a prefix acquisition response (step S9). The generated routing information is contained in the prefix acquisition response, and the resultant prefix acquisition response is transmitted (step S10).

(3) The response transmission unit 103 notifies another router (here, the child router 202) in the network N0 of routing information update (steps S12 to S17).

Hereafter, details of respective steps will be described.

In the step of (1), the request processing unit 104 notifies the routing information processing unit 108 of a prefix newly assigned to the child router 203 and information concerning the child router 203 of assignment destination (step S9). This step may be always executed irrespective of the state of the assignment management table 106 (i.e., this step may be executed regardless of whether there is another entry in the assignment management table), or the step may be executed only when it is previously known that there is another entry.

In the step of (2), the routing information processing unit 108 receives the assigned prefix and information concerning the child router 203 of the assignment destination as input information, generates routing information to be contained in a prefix acquisition response on the basis of the input information and the assignment management table 106, and returns the routing information to the request processing unit 104 (step S9). Specifically, the routing information processing unit 108 generates routing information on the basis of an already assigned prefix other than the received prefix and an address of a router assigned the already assigned prefix, and returns the routing information to the request processing unit 104. In the present example, the child router 203 is newly assigned the prefix “2001:0DB8:0:5678::/64”. Therefore, the routing information processing unit 108 generates routing information on the basis of a prefix other than this prefix and an address of a router assigned the prefix, and returns the routing information to the request processing unit 104. In other words, the routing information processing unit 108 returns the following routing information:

“2001:0DB8:0:1234::/64 via fe80::abcd:1234 (which represents that a network 2001:0DB8:0:1234::/64 can be arrived at via fe80::abcd:1234).

This routing information is contained in a prefix acquisition response and transmitted to the child router 203 (step S10).

In the step of (3), the routing information processing unit 108 generates a routing information update notice message on the basis of the previous input information (the prefix assigned to the child router 203 and information concerning the child router 203 of the assignment destination) and the assignment management table 106. This message conveys the possibility of update (addition, or deletion) of routing information. The routing information processing unit 108 transmits routing information update notice to a router already assigned a prefix (in the present example, the child router 202) via the response transmission unit 103 (step S13, step S12 will be described later). (It is also possible to divert a message according to an existing protocol for the routing information update notice. If the DHCPv6 PD (Prefix Delegation) is used, it is possible to divert a reconfigure message for the routing update notice. In the “ND Support to trigger the nodes refresh the other configuration” Vijayabhaskar A Kalusivalingam, T. Chown, S. Venaas, November 2003, internet-draft, draft-vijay-ipv6-icmp-refresh-otherconf-00.txt, an IPv6 router notice message is used as a notice message.)

When acquiring updated routing information, the child router 202 which has received the routing information update notice confirms the legality of the received routing information update notice (step S14), and transmits a routing information acquisition request to the parent router 201 (step S15). This message is received by the request reception unit 102 in the parent router 201, and sent to the routing information processing unit 108. The routing information processing unit 108 conducts processing on the message, generates a routing information notice message containing suitable routing information (step S16), and transmits the routing information notice message to the child router 202 (step S17). In the present example, a routing information notice containing the following routing information for the child router 203 is generated.

2001:0DB8:0:5678::/64 via fe80::5678:4321

The routing information generation may be conducted at the stage of S12 shown in FIG. 18, instead of the step S16. If there is a prefix that is not yet noticed with respect to connection or disconnection of another router, the parent router 201 can transmit routing information including the information.

Upon receiving the routing information, the child router 202 modifies the routing table (see FIGS. 13 to 17), and inserts routing information to head for 2001:0DB8:0:5678::/64. (If an address of a link local scope is used as an address of a router to be passed through, it is premised that a router on the receiving side (in the present example, a child router) can provide a suitable interface name and handle the address.)

When conveying the possibility of routing information update by using the routing information update notice message in the step (3) (step S13), selection can be conducted from the following four methods.

A first method is a method of sending only a pure notice which does not contain additional information relating to the updated routing information at all.

A second method is a method of causing a notice to the effect that there is update in the routing information to contain all routing information in the parent router 201 or updated routing information and sending the resultant notice.

A third method is a method of causing a notice to the effect that there is update in the routing information to contain information (such as a hash value) based on updated routing information, and sending the resultant notice. The notice may be made to contain information based on all routing information or other specific routing information, instead of the information based on updated routing information.

A fourth method is application of the third method, and it is a method of causing a notice to the effect that there is update in the routing information to contain information calculated on the basis of authentication information shared by the parent router 201 and the child router 202, and sending the resultant notice. Specifically, there are, for example, two methods (fourth-first method and fourth-second method). The fourth-first method is a method of causing a notice to the effect that there is update in routing information to contain a hash value H(R, K, t) calculated on the basis of updated routing information R, shared authentication information K and a time stamp t, the updated routing information R, and the time stamp t, and sending the resultant notice. The fourth-second method is a method of causing a notice to the effect that there is update in routing information to contain a hash value H1(R, t) calculated on the basis of updated routing information R and a time stamp t, and a hash value H2(K, a random number, t) calculated on the basis of the shared authentication information K, a random number and a time stamp t, and sending the resultant notice.

Processing conducted in the child router 202 in association with each of the above-described notices will now be described.

As for processing conducted by the child router 202 in association with the first method, the child router 202 confirms the legality of the routing information update notice message, and then transmits a routing information acquisition request to the parent router 201. And the child router 202 receives all routing information existing in the parent router 201 from the parent router 201, and takes in all routing information as its own routing information. As a variant of this method, a method in which routing information the child router 202 currently has is added to the routing information acquisition request and the parent router 201 provides its difference is also conceivable. In the latter case, the child router 202 may add the routing information under the present state as it is to the routing information acquisition request and transmit the resultant routing information acquisition request, or may add a hash value of the routing information under the present state. If the hash value is transmitted, the amount of data transmission can be reduced.

As for processing conducted by the child router 202 in association with the second method, the child router 202 confirms the legality of the routing information update notice message, and then takes in routing information contained therein as its own routing information.

As for processing conducted by the child router 202 in association with the third method, the child router 202 transmits a routing information acquisition request containing information (such as a hash value) noticed from the parent router 201 to the parent router 201. Upon receiving this request, the parent router 201 gives a notice of routing information associated with information contained in the request to the child router 202, and the child router 202 takes in the routing information as its own routing information.

Hereafter, processing conducted by the child router 202 in association with the fourth method will be described. As for processing conducted by the child router 202 in association with the fourth-first method, the child router 202 verifies the received hash value H. If the received hash value H is legal, the child router 202 takes in the received routing information as it is. In other words, the child router 202 calculates the hash value H(R, K, t) itself by using the received routing information R, time stamp t and authentication information K. If this value coincides with the received hash value H, the child router 202 regards the value as legal, and takes in the received routing information. As for processing conducted by the child router 202 in association with the fourth-second method, the child router 202 calculates an associated different value (response value) by using the received hash value H2 as a challenge value, and returns the calculated different value together with the other received hash value H1. After this, when the parent router 201 actually sends the routing information R, the routing information may be encrypted by the shared authentication information K.

In the above-described method, the routing information update notice may be transmitted in a multicast fashion instead of the unicast fashion. If the multi-cast form is used, the fourth method becomes difficult. As a variant of the fourth method, however, it is possible to add authentication information that certifies only the legality of the parent router 201 to the routing information update notice.

The case where the validity term of the prefix assigned to a child router by the parent router has expired will now be described. As an initial state, the network topology shown in FIG. 5, the assignment management table 106 shown in FIG. 4, and the network identification information table 105 shown in FIG. 6 are supposed. It is supposed that suitable routing information is already set in each router on the basis of the present proposal.

The validity term of the assignment management table 106 is periodically updated in the assignment management table update unit 107. At that time, a prefix for which the validity term has expired is detected. The routing information processing unit 108 is notified of the detected prefix.

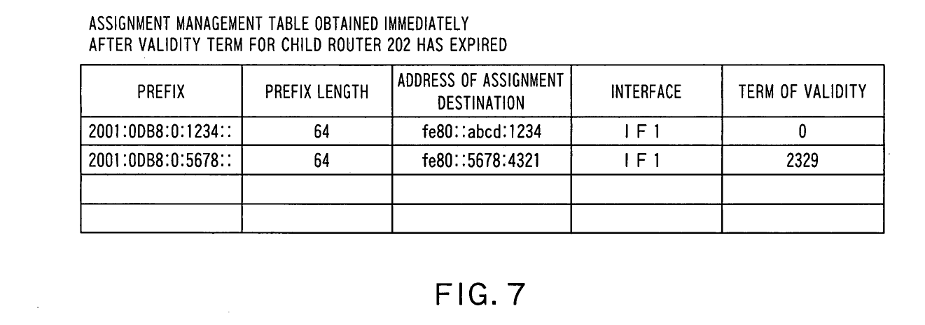

For example, the assignment management table 106 shown in FIG. 7 shows a state in which the validity term in the assignment management table 106 shown in FIG. 4 is subjected to subtraction and the validity term of the prefix (2001:0DB8:0:1234::/64) assigned to the child router 202 has expired. Accordingly, the assignment management table update unit 107 sends a notice containing [child router 202, prefix 2001:0DB8:0:1234::/64, fe80::abcd:1234] to the routing information processing unit 108.

Upon receiving this notice, the routing information processing unit 108 retrieves all assigned routers (in the present example, the child router 203) other than the child router 202 from the assignment management table 106, and transmits a routing information update notice to them. Upon receiving the routing information update notice, the child router transmits a routing information acquisition request to the parent router 201, and acquires routing information after update from the parent router 201. Specifically, two methods: a method of receiving a notice of a route that has become invalid and removing the route, and a method of receiving a notice of all routes after the update and updating the whole are conceivable. In either case, the parent router 201 can use the above-described four notice methods.

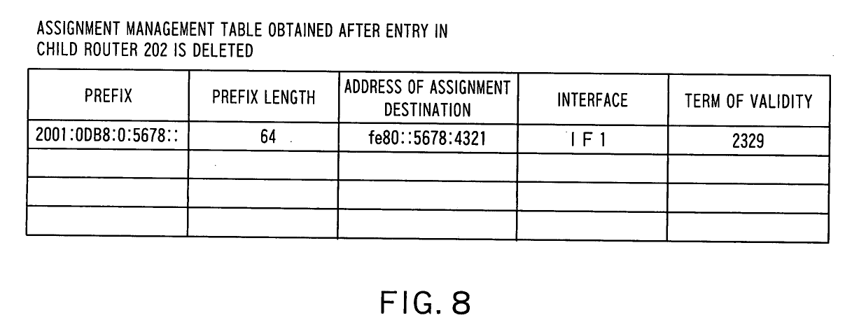

As for an entry in the assignment management table 106 for which the validity term has expired, the assignment management table update unit 107 deletes the entry, when the notice from the assignment management table update unit 107 to the routing information processing unit 108 is completed. As a result, the assignment management table becomes as shown in FIG. 8.

The case where a prefix becomes invalid because of expiration of the validity term has been described. Alternatively, it is also possible that the child router 202 returns a prefix assigned to itself to the parent router 201 and the parent router 201 makes the prefix invalid. In this case as well, the parent router 201 notifies the other child router (in the present example, the child router 203) of routing information after update in the same way.

Heretofore, the processing sequence between the parent router 201 and the child routers 202 and 203 has been mainly described. Processing conducted in each of the parent router 201 and the child routers 202 and 203 will now be described in further detail.

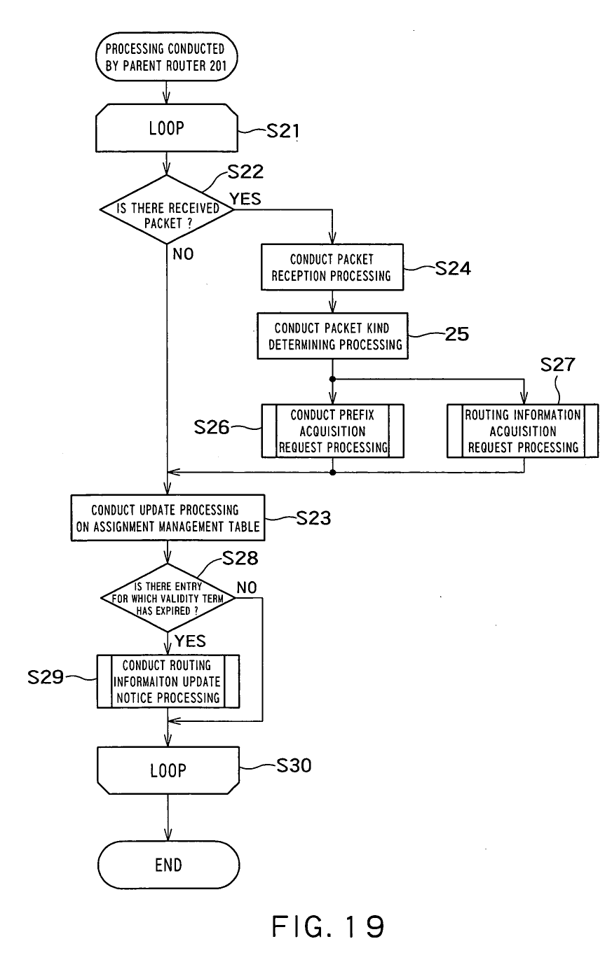

FIG. 19 is a flow chart showing the flow of whole processing conducted by the parent router 201.

The parent router 201 determines at fixed time intervals whether a packet has been received (step S22). If it is judged that a packet is not received (no at the step S22), the parent router 201 conducts update of the assignment management table 106, such as an alteration of the validity term (step S23).

On the other hand, if it is judged that a packet is received (YES at the step S22), the parent router 201 conducts reception processing such as demodulation on the received packet (step S24) and then judges the kind of the received packet (step S25).

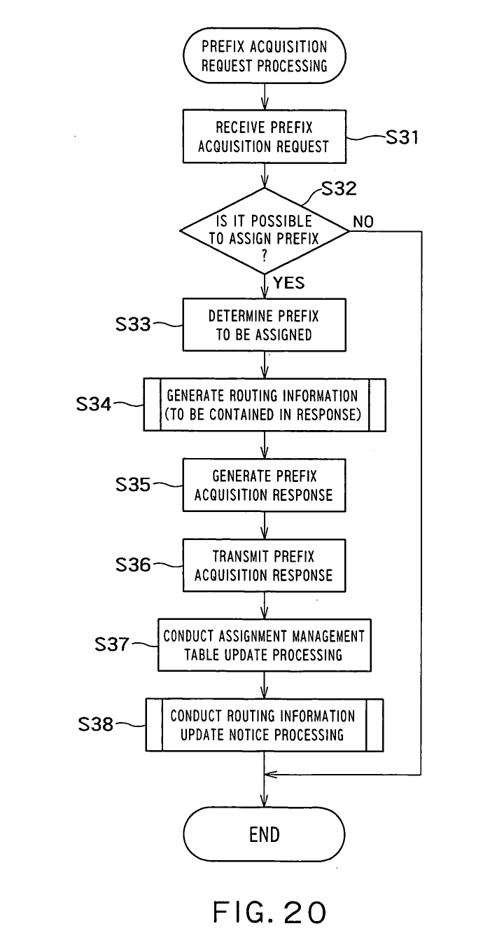

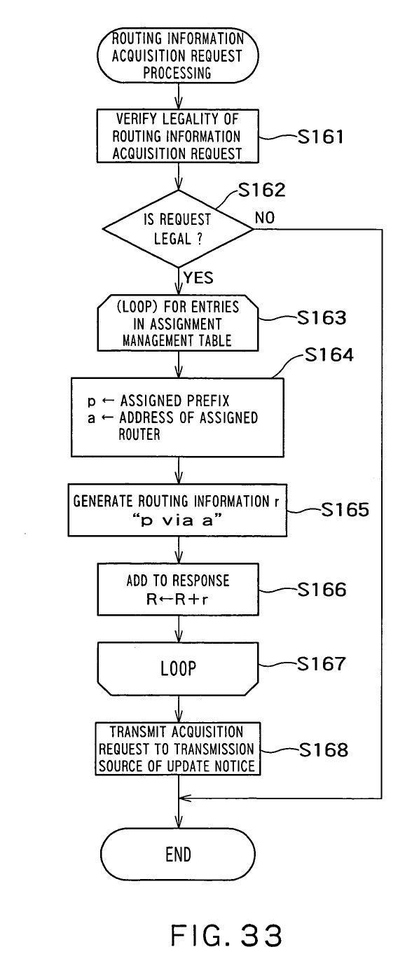

If the kind of the packet is a prefix acquisition request, the parent router 201 conducts prefix acquisition request processing (see FIG. 20) (step S26). If the kind of the packet is a routing information acquisition request, the parent router 201 conducts routing information acquisition request processing (see FIG. 33) (step S27).

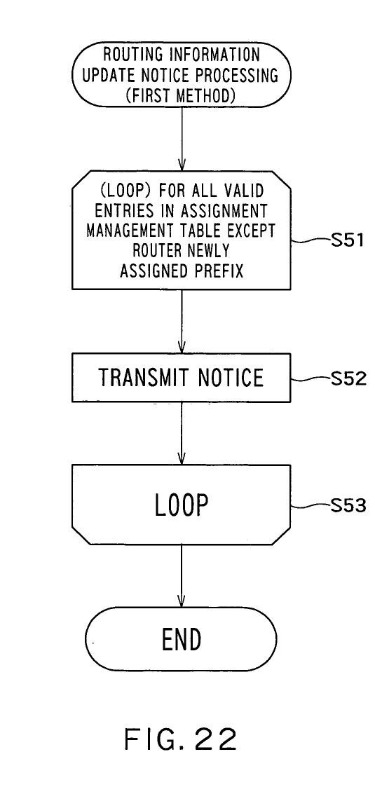

Upon conducting the prefix acquisition request processing or the routing information acquisition request processing, the parent router 201 updates the assignment management table 106 as occasion demands (step S23) and then determines whether there is an entry for which the validity term has expired (step S28). If there is not such an entry (no at the step S28), the parent router 201 returns to the step S21 (step S30). If there is such an entry (YES at the step S28), the parent router 201 conducts routing information update notice processing (see FIGS. 22 to 26) (step S29) and returns to the step S22 (step S30). In FIG. 19, the steps S21 and S30 mean that loop processing of steps interposed between them is conducted.

FIG. 20 is a flow chart showing the prefix acquisition request processing (step S26) in FIG. 19 in detail.

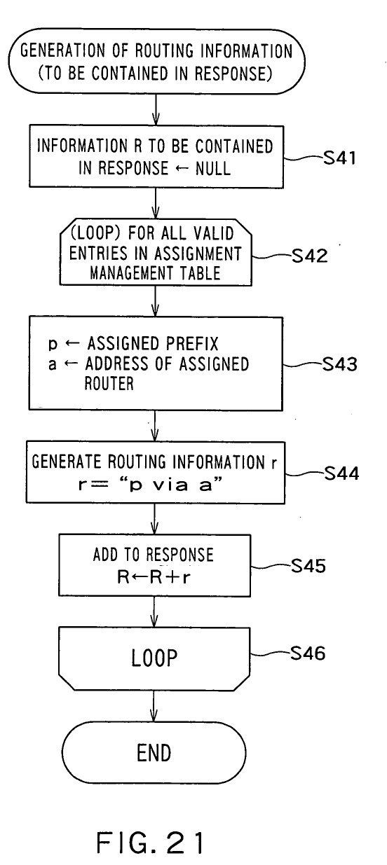

Upon receiving a prefix acquisition request (step S31), the parent router 201 determines whether a new prefix can be assigned (step S32). If a new prefix cannot be assigned (no at the step S32), the parent router 201 returns a notice to that effect. On the other hand, if a new prefix can be assigned (YES at the step S32), the parent router 201 determines a new prefix to be newly assigned (step S33), and generates routing information in accordance with an algorithm shown in FIG. 21 (step S34). In other words, the parent router 201 generates [assigned prefix via address of assigned child router] for all valid entries in the assignment management table 106 (steps S41 to S46). Referring back to FIG. 20, the parent router 201 which has generated the routing information generates a prefix acquisition response containing the newly assigned prefix and the generated routing information (step S35), and transmits the generated prefix acquisition response to the transmission source of the prefix acquisition request (step S36). Thereafter, the parent router 201 registers the newly assigned prefix in the assignment management table 106 (step S37). In addition, the parent router 201 conducts routing information update notice processing in accordance with one of processing procedures in the flow charts shown in FIGS. 22 to 26 (respectively associated with the above-described first to fourth-second methods) (step S38).

FIG. 22 is a flow chart showing execution of the above-described first method.

The parent router 201 transmits a routing information update notice (that does not contain routing information) to the effect that routing information has been updated, to all routers (entries) other than the child router newly assigned a prefix (steps S51 to S53).

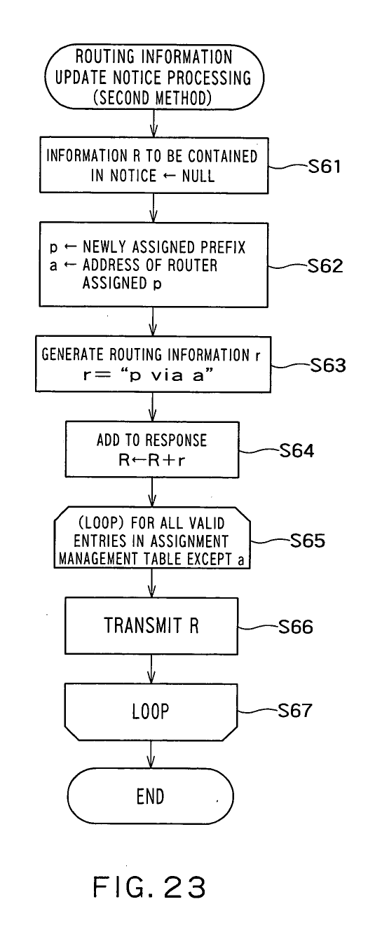

FIG. 23 is a flow chart showing execution of the above-described second method.

The parent router 201 generates routing information by using an address of a child router newly assigned a prefix and the new prefix (steps S61 to 564), and transmits a routing information update notice containing the routing information to all child routers (entries) other than the child router newly assigned the prefix (steps S65 to 567).

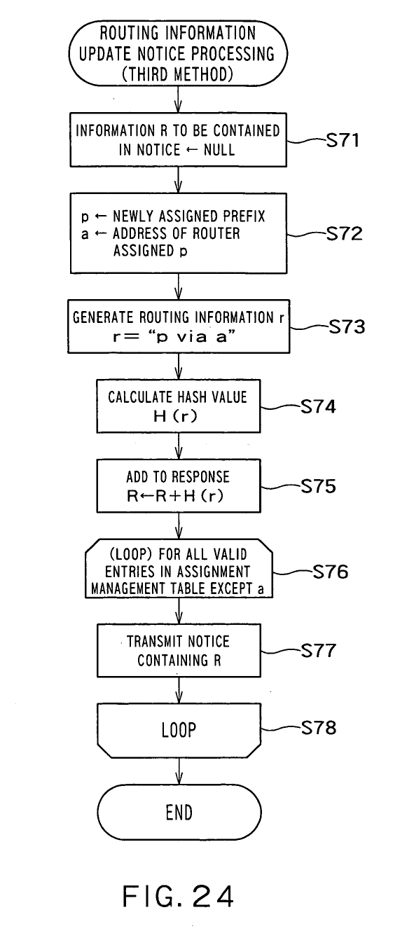

FIG. 24 is a flow chart showing execution of the above-described third method.

The parent router 201 generates routing information by using an address of a child router newly assigned a prefix and the new prefix (steps S71 to S73), calculates a hash value of the generated routing information (step S74), and transmits a routing information update notice containing the calculated hash value to all child routers (entries) other than the child router newly assigned the prefix (steps S75 to S78).

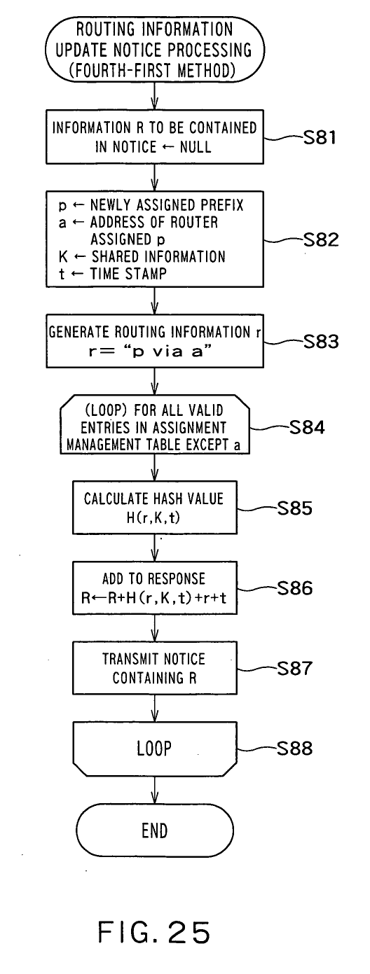

FIG. 25 is a flow chart showing execution of the above-described fourth-first method.

The parent router 201 generates routing information r by using an address of a router newly assigned a prefix and the new prefix (steps S81 to S83), and generates a hash value H(r, K, t) by using the generated routing information r, authentication information K shared between the parent router and child routers, and a time stamp t, for each of entries of all child routers (entries) other than the child router newly assigned the prefix (steps S84 to S86). The parent router 201 transmits a routing information update notice containing the hash value H(r, K, t), the generated routing information r and the time stamp t for each entry (steps S87 and S88).

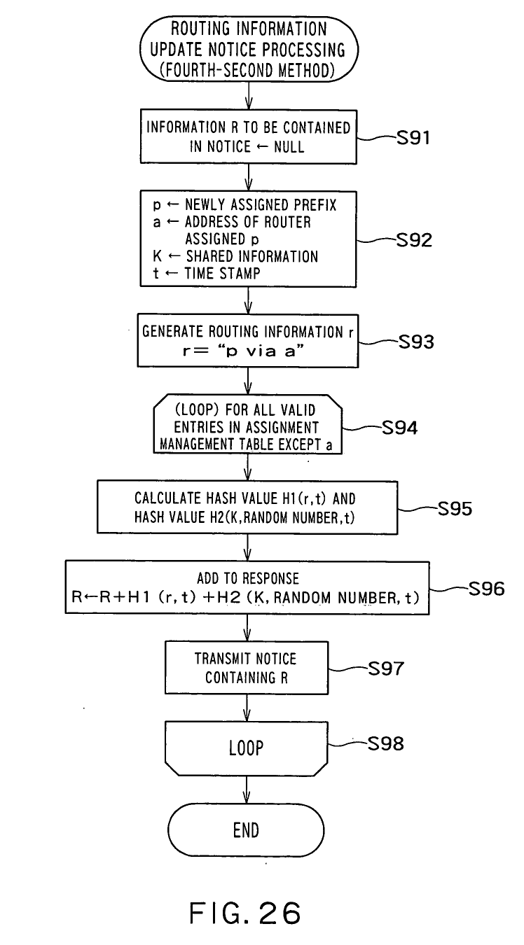

FIG. 26 is a flow chart showing execution of the above-described fourth-second method.

The parent router 201 generates routing information r by using an address of a router newly assigned a prefix and the new prefix (steps S91 to S93), and generates a hash value H1(r, t) and a hash value H2(K, random number, t) by using the generated routing information r, authentication information K shared between the parent router and child routers, and a time stamp t, for each of entries of all child routers (entries) other than the child router newly assigned the prefix (steps S94 to S96). The parent router 201 transmits a routing information update notice containing the hash value H1(r, t) and the hash value H2(K, random number, t) every entry (steps S97 and S98).

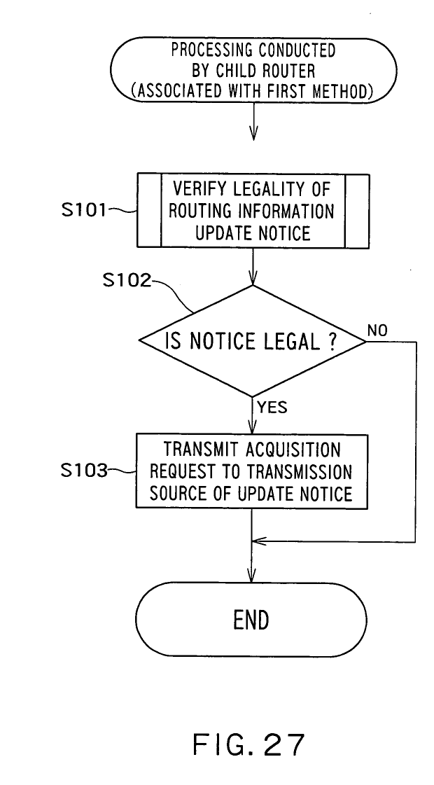

FIGS. 27 to 31 are flow charts respectively showing processing steps conducted by a child router that has received a routing information update notice by using the first to fourth-second methods.

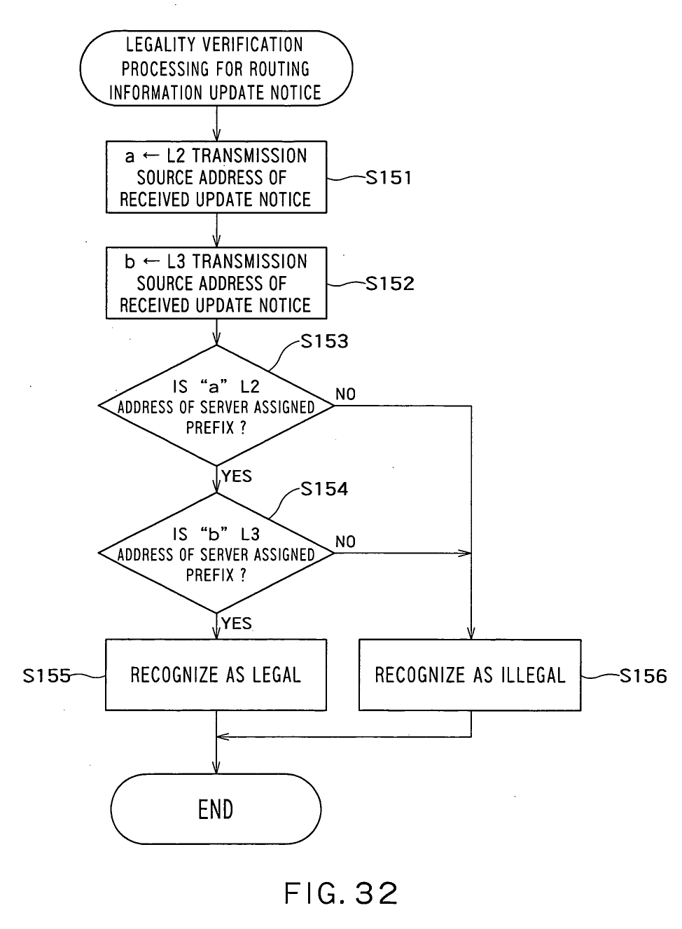

As shown in FIG. 27, the child router that has received the routing information update notice by using the first method first conducts legality verification processing on the routing information update notice shown in FIG. 32 (step S101). In other words, the child router determines whether a data link layer address and a network layer address in the received routing information update notice coincide with addresses of the parent router 201 which has assigned a prefix to the child router itself as shown in FIG. 32. If both of them coincide, the child router recognizes the routing information update notice as legal (steps S151 to S155). If at least one of them does not coincide, the child router recognizes the routing information update notice as illegal (steps S151 to S154 and S156). Referring back to FIG. 27, if the child router recognizes the received routing information update notice as legal (YES at step S102), the child router transmits a routing information acquisition request to the transmission source of the routing information update notice (the parent router 201) (step S103).

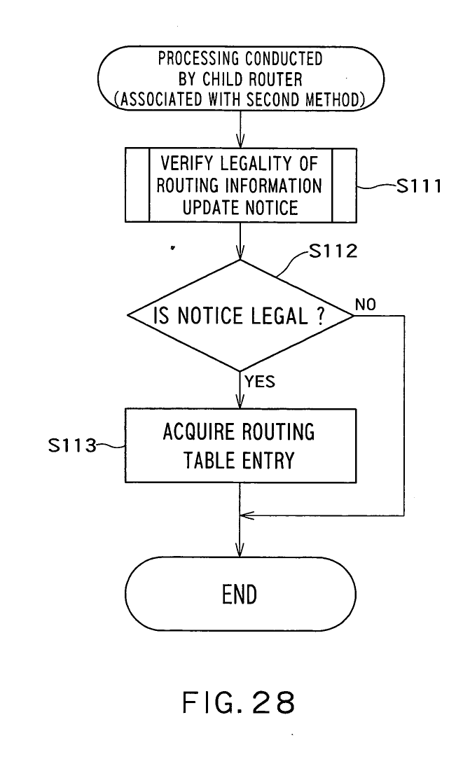

As shown in FIG. 28, the child router that has received a routing information update notice by using the second method verifies legality of the received routing information update notice (step S111)(see FIG. 32). If the child router recognizes the routing information update notice as legal (YES at step S112), the child router updates the routing table of its own node on the basis of routing information contained in the routing information update notice (step S113).

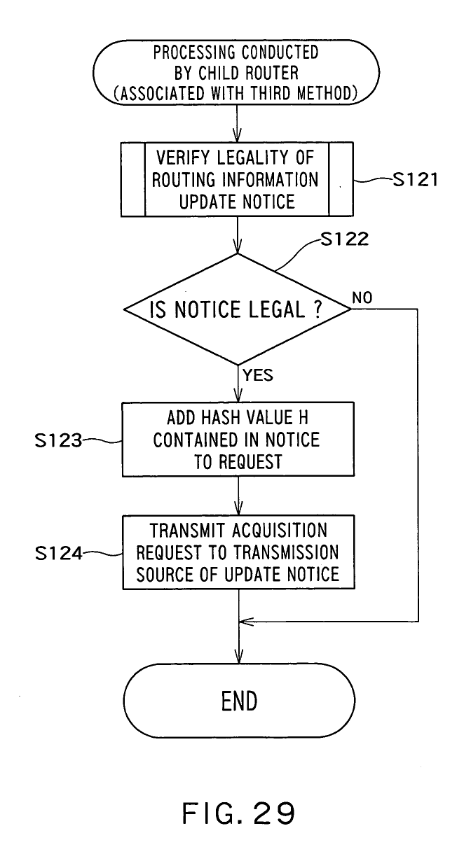

As shown in FIG. 29, the child router that has received a routing information update notice by using the third method verifies legality of the received routing information update notice (step S121)(see FIG. 32). If the child router recognizes the routing information update notice as legal (YES at step S122), the child router causes the routing information acquisition request to contain the hash value H contained in the routing information update notice and transmits the resultant routing information acquisition request to the parent router 201 (steps S123 and S124).

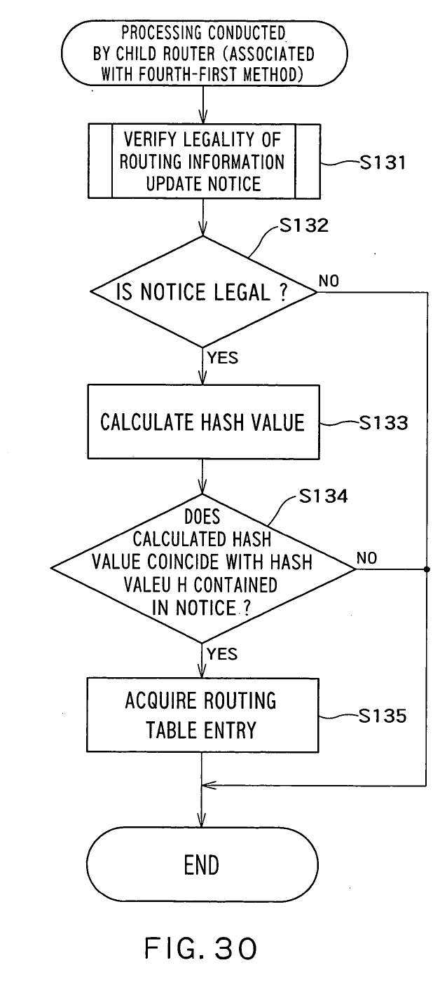

As shown in FIG. 30, the child router that has received a routing information update notice by using the fourth-first method verifies legality of the received routing information update notice (step S131)(see FIG. 32). If the child router recognizes the routing information update notice as legal (YES at step S132), the child router further conducts verification based on the hash value. In other words, the child router calculates the hash value itself by using information (the routing information r and the time stamp t) received from the parent router 201 and previously retained information (authentication information K), and determines whether the calculated hash value coincides with the hash value H contained in the routing information update notice (steps S133 and S134). If they coincides with each other (YES at the step S134), the child router updates the routing table in its own node on the basis of the routing information contained in the routing information update notice (step S135). The legality verification processing at the step S131 may be omitted in order to conduct verification based on the hash value.

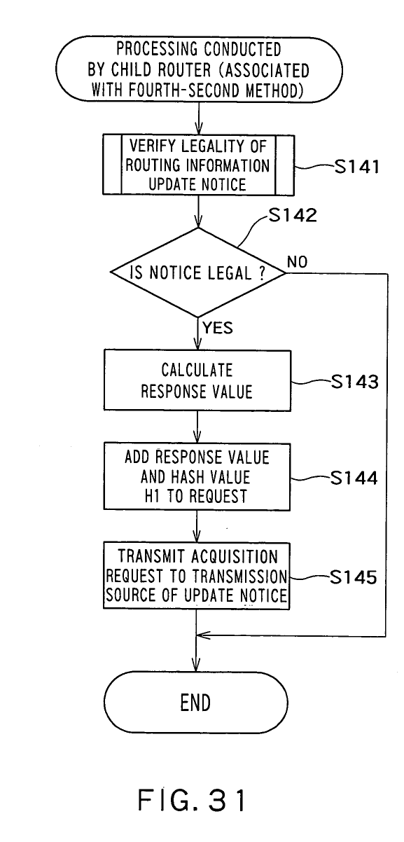

As shown in FIG. 31, the child router that has received a routing information update notice by using the fourth-second method verifies legality of the received routing information update notice (step S141)(see FIG. 32). If the child router recognizes the routing information update notice as legal (YES at step S142), the child router calculates a response value by using the hash value H2(K, random number, and t) contained in the routing information update notice (step S143). The child router causes a routing information acquisition request to contain the calculated response value and the hash value H1(r, t) and transmits the resultant routing information acquisition request to the parent router 201 (steps S144 and S145).

FIG. 33 is a flow chart showing a flow of routing information acquisition request processing (step S27 in FIG. 19) conducted by the parent router 201.

Upon receiving a routing information acquisition request from a child router, the parent router 201 verifies legality of the routing information acquisition request (step S161). If a hash value or the above-described response value etc. is contained in the routing information acquisition request, the parent router 201 conducts verification by using the hash value or the response value etc. Otherwise, verification based on the data link layer address and network layer address is conducted in the same way as FIG. 32.

If the parent router 201 judges the routing information acquisition request to be legal (YES at step S162), the parent router 201 generates routing information by using a prefix and an address of a router assigned the prefix for each of entries in the assignment management table 106 (steps S163 to S167), and transmits the routing information to a transmission source (child router) of the routing information acquisition request (step S168). However, if the routing information acquisition request is a request concerning only specific routing information (for example, routing information concerning a router newly assigned a prefix), the parent router 201 transmits only the routing information (step 168).

Another embodiment (hereafter referred to as second embodiment) according to the present invention will now be described. In the second embodiment, a notice control function is further added to the first embodiment. Hereafter, the second embodiment will be described in detail.

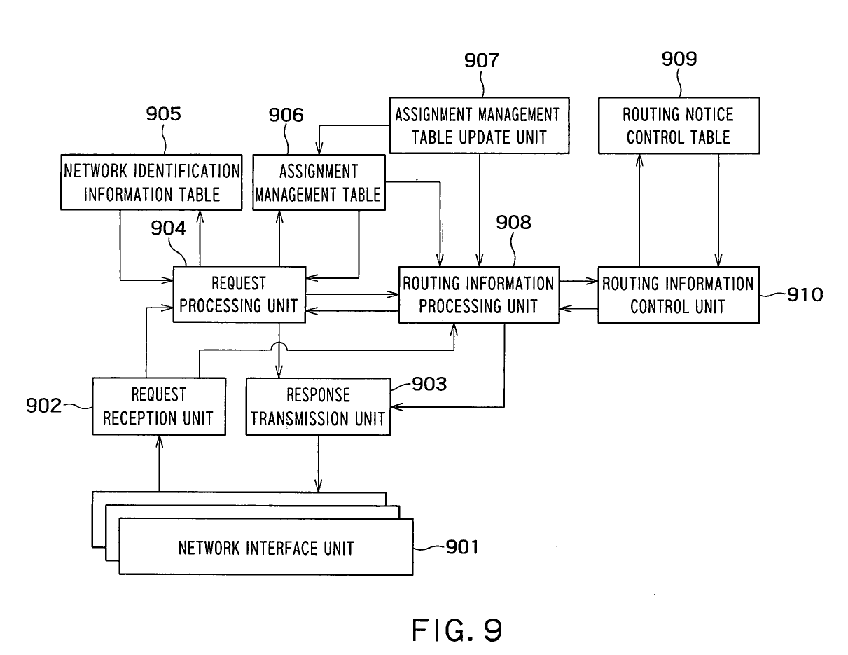

FIG. 9 is a block diagram showing a configuration of a network connection apparatus (router) according to a second embodiment of the present invention. A routing information control unit 910 and a routing notice control table 909 have been added to the block diagram shown in FIG. 1. (For convenience, other components are denoted by different reference numerals. However, those components have functions similar to those in FIG. 1.)

The routing information control unit 910 is supplied with a routing information update notice generated by a routing information processing unit 908 or, routing information or routing information notice which triggered generation of the routing information update notice, its destination, and the previously set routing notice control table 909. The routing information control unit 910 determines whether to actually transmit the routing information update notice or the routing information notice to the other party. When permitting the transmission, the routing information control unit 910 changes the input routing information update notice or routing information notice so as to cause the input routing information update notice or routing information notice to contain only routing information actually permitted to be transmitted, and returns its result to the routing information processing unit 908. When not permitting the transmission, the routing information control unit 910 returns a signal to that effect to the routing information processing unit 908. If the finally transmitted routing information update notice and routing information notice contain a hash value or authentication information etc, the routing information processing unit 908 adds the value after receiving a response from the routing information control unit 910.

When finally sending a routing information update notice containing the routing information, it is also possible that the routing information processing unit 908 inputs a routing information update notice containing routing information to the routing information control unit 910 and the routing information control unit executes the above by deleting routing information contained in the routing information update notice.

Furthermore, the routing information control unit 910 is supplied with a prefix acquisition response containing routing information generated by the routing information processing unit 908 or a prefix acquisition response that does not contain routing information, routing information that might be contained in the prefix acquisition response, and the previously set routing notice control table 909. The routing information control unit 910 conducts suitable filtering processing, and returns a prefix acquisition response containing only routing information to be actually given as a notice, to the routing control processing unit 908.

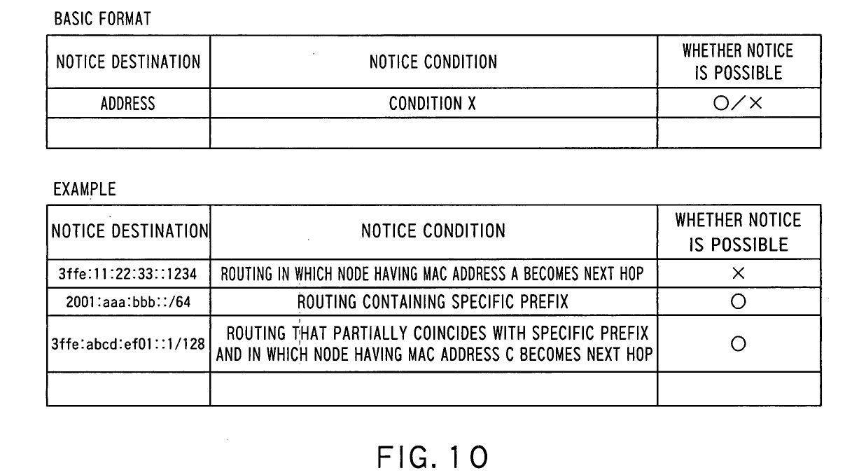

The routing notice control table 909 can have various formats according to the purpose. FIG. 10 shows a basic format of the routing notice control table and its specific example. The routing notice control table 909 includes three items, i.e., notice destination, notice condition, and whether notice is possible. As examples of the notice condition, some conditions concerning the routing to be given to the notice destination as a notice are as follows:

(a) routing on which a node having a specific MAC address becomes a next hop;

(b) routing on which a node having a specific MAC address does not become a next hop;

(c) routing that partially coincides with a specific prefix;

(d) routing that does not coincide with a specific prefix;

(e) routing that partially coincides with a specific prefix, and in which a node having a specific MAC address becomes a next hop;

(f) routing that partially coincides with a specific prefix, and in which a node having a specific MAC address does not become a next hop;

(g) routing that does not coincide with a specific prefix, and in which a node having a specific MAC address becomes a next hop;

(h) routing that does not coincide with a specific prefix, and in which a node having a specific MAC address does not become a next hop;

(i) routing in which a node having a specific ID becomes a next hop; and

(j) routing in which a node having a specific ID does not become a next hop.

Besides, various conditions can be set so long as they are conditions concerning unique information and prefix of a router assigned a prefix. The condition “node having a specific ID” is contained in the condition (i) and condition (j). As this ID, an ID of a router manager (user) or an ID defined on a prefix assignment protocol can be used.

An outline of processing (notice control processing) conducted by the routing information control unit 910 will now be described.

(1) The notice destination of the input routing information update notice, routing information notice, or prefix acquisition response is compared with a notice destination of the routing notice control table 909 to search for a matching entry. The comparison is conducted on the basis of the longest match principle. If there isn't a matching entry at this stage, the processing is finished.

(2) The notice condition of the matching entry is applied to information contained in the input routing information update notice, routing information notice, or prefix acquisition response. If the condition is satisfied, the column as to whether notice is possible is checked. If the notice is possible, the notice is conducted. If the notice is impossible, the notice is not conducted. If the condition is not satisfied, default processing previously set by the manager is conducted.

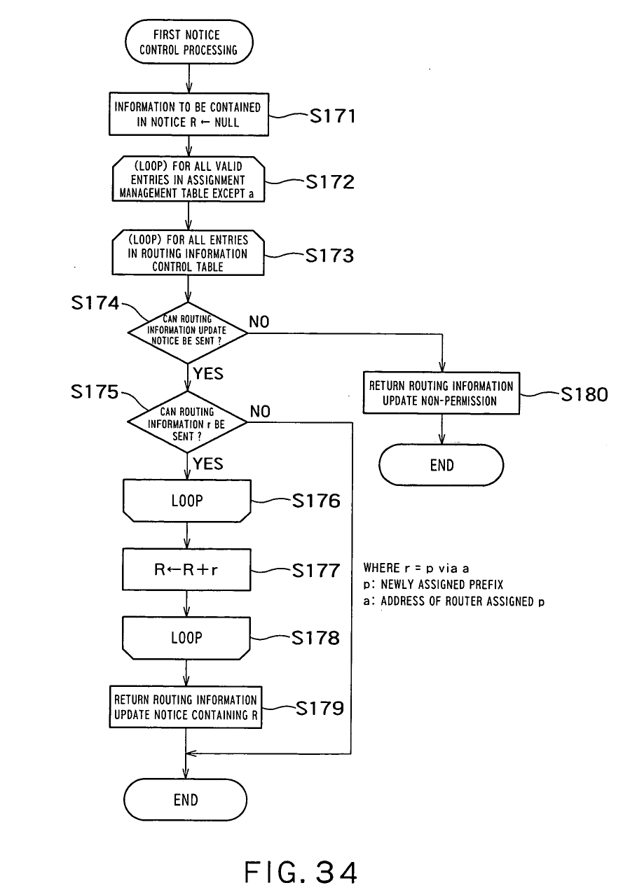

The processing in (1) and (2) will be described in further detail with reference to FIGS. 34 to 36.

FIG. 34 is a flow chart showing notice control processing (first notice control processing) conducted when transmitting a routing information update notice containing routing information (here a routing information update notice associated with the second or fourth-first method) to a child router. The parent router 201 associates notice destinations (entries except a child router assigned a new prefix in the assignment management table 906) with the routing notice control table 909, and thereby determines whether the routing information notice can be sent to respective notice destinations (step S174). If the notice is prohibited, the parent router 201 returns a non-permission response to the routing information processing unit 908 (step S180). If the notice is permitted, the parent router 201 determines whether a notice of an address of a child router newly assigned a prefix and routing information r generated by using this prefix can be sent (step S175). The parent router 201 causes a routing information update notice to contain routing information only for notice destinations that can be notified, and returns the resultant routing information update notice to the routing information processing unit 908 (steps S177 and S179).

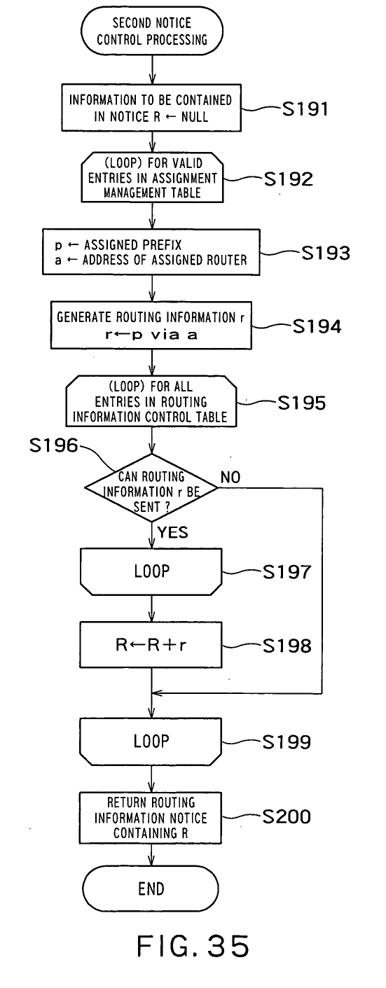

FIG. 35 is a flow chart showing notice control processing (second notice control processing) conducted when transmitting a routing information notice to a child router. Upon receiving a routing information acquisition request from the child router, the parent router 201 confirms legality of the routing information acquisition request by using a method similar to that described with reference to the step S161 shown in FIG. 33, then generates routing information for each of entries in the assignment management table 906 (steps S192 to S194), associates the routing information and notice destination of notice with the routing notice control table 909, determines whether a notice of each routing information can be sent (steps S195 to S197), causes only routing information that can be sent as a notice to be contained in a routing information notice (step S198), and returns resultant routing information notice to the routing information processing unit 908(step S200).

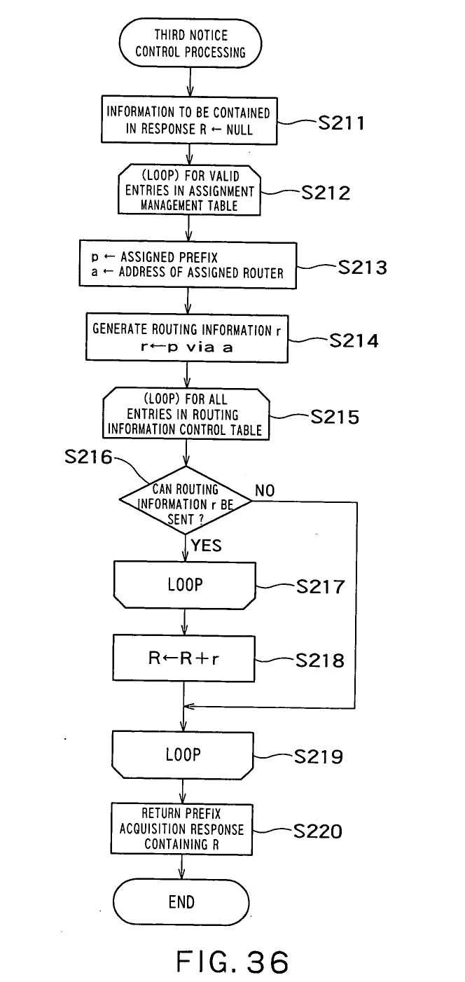

FIG. 36 is a flow chart showing notice control processing (third notice control processing) conducted when transmitting a prefix acquisition response to a child router. Upon receiving a prefix acquisition request, the parent router 201 generates routing information for each of entries in the assignment management table 906 (steps S212 to S214), associates the routing information and notice destination of notice with the routing notice control table 909, determines whether a notice of each routing information can be sent (steps S215 to S217), causes only routing information that can be sent as a notice to be contained in a prefix acquisition response (step S218), and returns resultant prefix acquisition response to the routing information processing unit 908 (step S220).

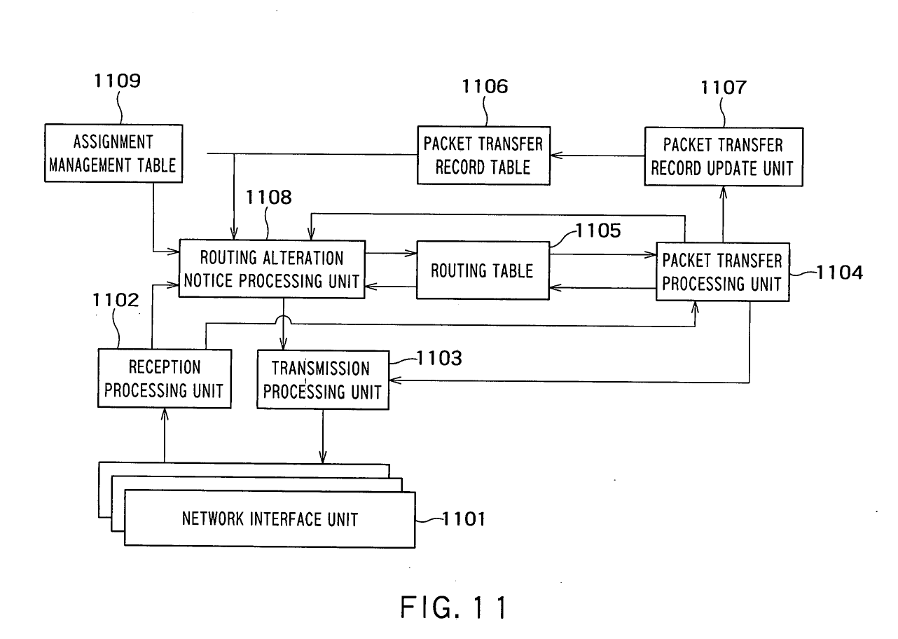

FIG. 11 is a block diagram showing a configuration of a network connection apparatus (router) according to a third embodiment of the present invention. In FIG. 11, reference numeral 1101 denotes a network interface unit which transmits and receives packets. Numeral 1102 denotes a request reception unit which outputs received packets to output destinations corresponding to their contents. Numeral 1103 denotes a transmission processing unit which executes a transmission request issued by another function block. Numeral 1104 denotes a packet transfer processing unit which determines a transfer destination of a packet. Numeral 1105 denotes a routing table referred to by the packet transfer processing unit 1104 when determining a transfer destination of a packet. Numeral 1106 denotes a packet transfer record table used to record flow information of a transferred packet. Numeral 1107 denotes a packet transfer record update unit that updates information in the packet transfer record table 1106. Numeral 1108 denotes a routing alteration notice processing unit which conducts processing on a routing alteration notice packet (described later) received by the reception processing unit 1102. FIG. 11 shows only function blocks required to describe the present embodiment. It is also possible to add the configuration shown in FIG. 11 to the configuration shown in FIG. 1 or 9.

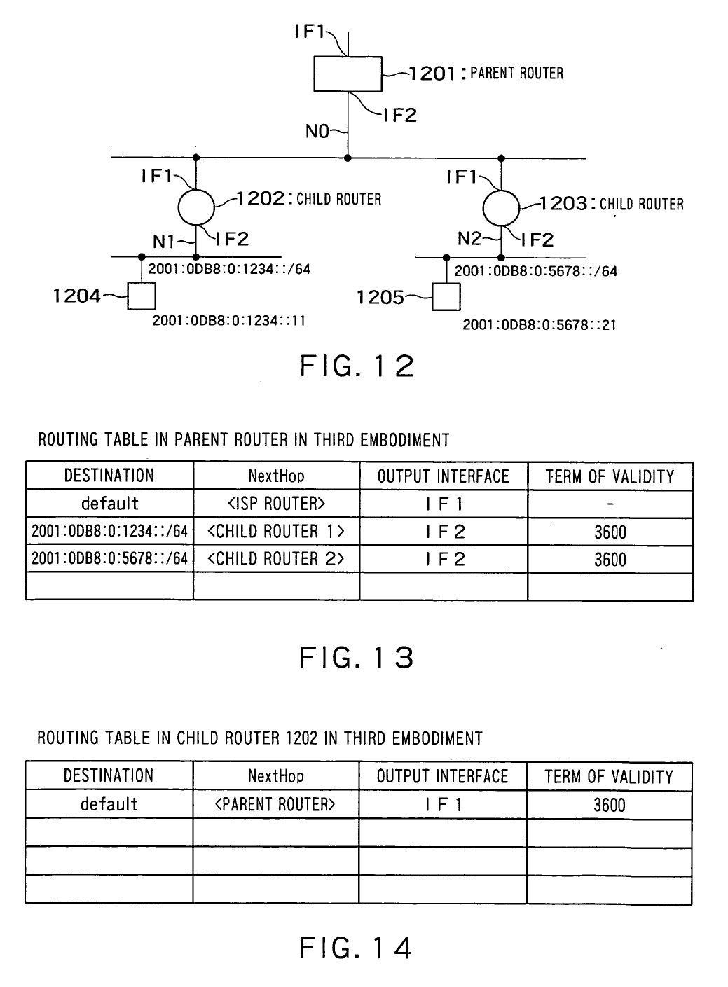

FIG. 12 is a configuration diagram of a network system according to the present embodiment.

Each of a parent router 1201, and child routers 1202 and 1203 includes the function blocks shown in FIG. 11. Nodes 1204 and 1205 are, for example, user apparatuses.

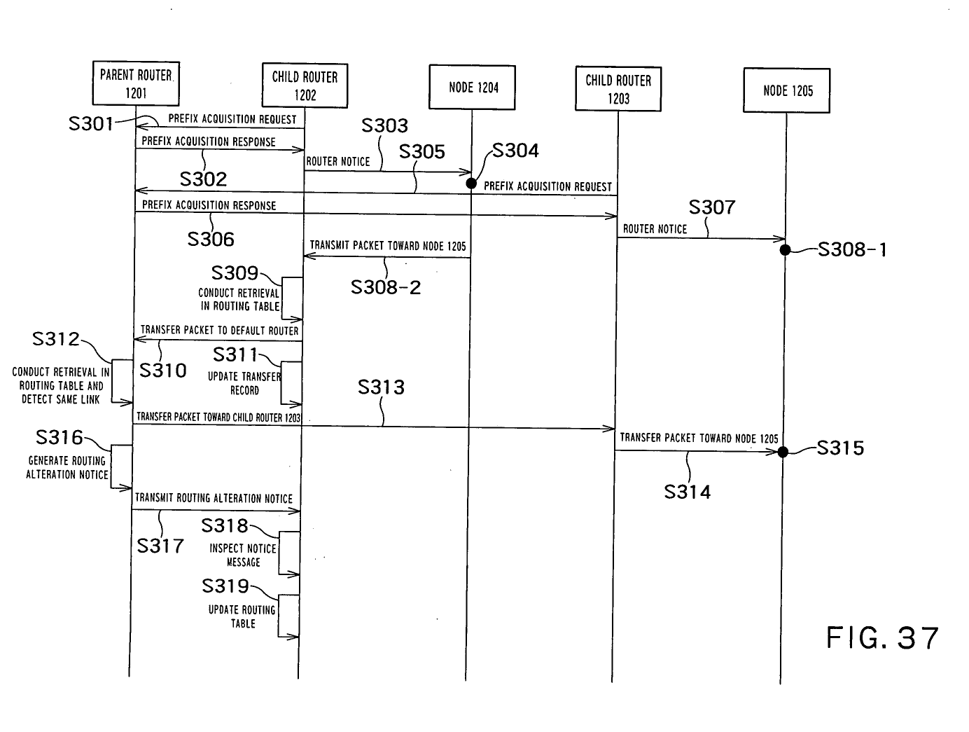

FIG. 37 is a diagram showing a sequence of processing conducted by the network system shown in FIG. 12.

Prefix delegation is completed between the parent router 1201 and the child router 1202 shown in FIG. 12. A prefix “2001:0DB8:0:1234::/64” is assigned to a network N1 subordinate to the child router 1202 (steps S301 and S302). The node 1204 on the network N1 acquires an address “2001:0DB8:0:1234::11” on the basis of the prefix (steps S303 and S304). In the same way, prefix delegation is completed between the parent router 1201 and the child router 1203 as well. A prefix “2001:0DB8:0:5678::/64” is assigned to a network N2 subordinate to the child router 1203 (steps S305 and S306). The node 1205 on the network N2 acquires an address “2001:0DB8:0:5678::21” on the basis of the prefix (steps S307 and S308-1).

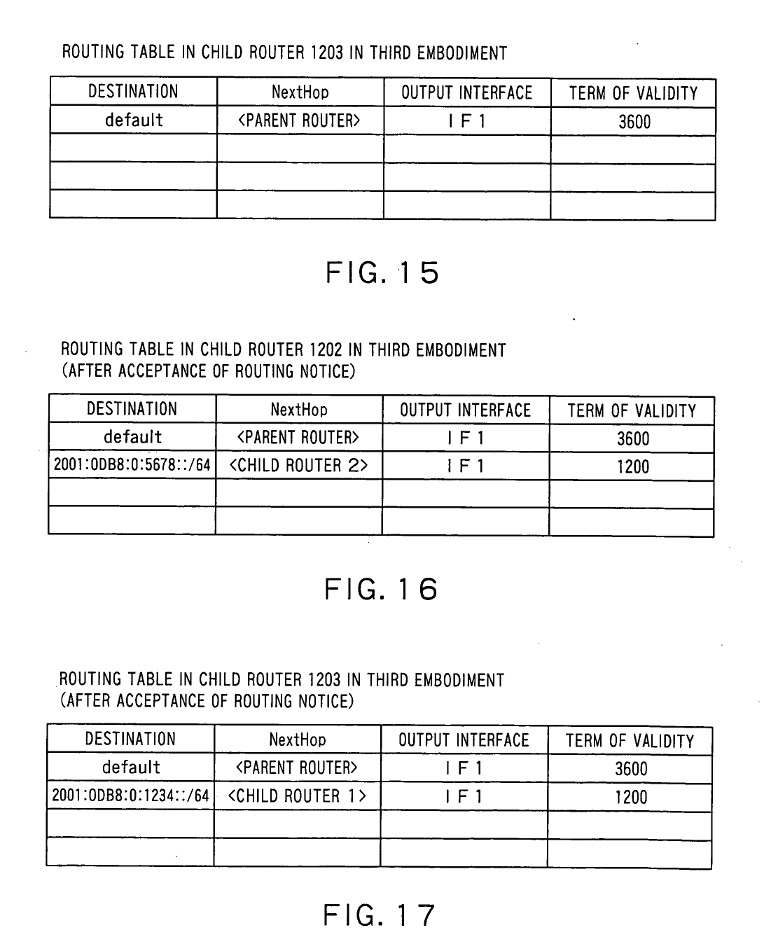

The routing table in the parent router 1201 at the current time is shown in FIG. 13, and the routing tables in the child router 1202 and the child router 1203 at the current time are shown in FIGS. 14 and 15, respectively. As shown in FIGS. 14 and 15, default routes in the child router 1202 and the child router 1203 indicate the parent router, and the child router 1202 and the child router 1203 do not have routing information to the networks N2 and N1 respectively subordinate to the child router 1203 and the child router 1202.

It is supposed that the node 1204 transmits a packet to the node 1205 under this state. The packet transmitted toward the node 1205 by the node 1204 (step S308-2) has “2001:0DB8:0:5678::21” as the destination address. The child router 1202 receives the packet in the reception processing unit 1102. Since the packet is not directed to itself, the child router 1202 delivers the packet to the packet transfer processing unit 1104 (step S309). The packet transfer processing unit 1104 conducts retrieval in the routing table 1105, and recognizes that the routing table 1105 has not routing information for the network “2001:0DB8:0:5678::/64”. Therefore, the packet is transferred toward the parent router 1201 that is the default route (step S310). This transfer processing is conducted from the packet transfer processing unit 1104 via the transmission processing unit 1103 and the network interface unit 1101. In parallel with this transfer processing, the packet transfer processing unit 1104 notifies the packet transfer record update unit 1107 of information of the transferred packet (such as the transmission source IP address, reception destination IP address, protocol, port number, and transfer time). The packet transfer record update unit 1107 updates the packet record table 1106 on the basis of the information (step S311).

Upon receiving a packet having “2001:0DB8:0:5678::21” specified as the destination address, the parent router 1201 conducts retrieval in its own routing table 1105, and knows that the network “2001:0DB8:0:5678::/64” can be arrived at via the child router 1203 (step S312). The parent router 1201 transmits this packet toward the child router 1203 (step S313). The child router 1203 transfers this packet to the node 1205 (step S314). The node 1205 receives the packet (step S315). At the step S312, the parent router 1201 recognizes that the child router 1202 serving as the relay source of the packet and the child router 1203 serving as the relay destination are connected to the same network (the same segment) N0. Therefore, the parent router 1201 generates a routing alteration notice (step S316), and transmits the routing alteration notice to the child router 1202 serving as the relay source of the packet (step S317).

The packet transfer processing unit 1104 decides whether to generate the routing alteration notice. The decision criteria are as follows:

the packet received by itself (the parent router 1201) is a packet that contains an address of a network layer containing a prefix assigned by itself (the parent router 1201), as the transmission source address;

the packet received by itself (the parent router 1201) is a packet that contains an address of a network layer containing a prefix assigned by itself (the parent router 1201), as the reception destination address;

a transmission source MAC address of the packet is that of a child router assigned a prefix by itself (the parent router 1201); and

if a packet is transferred on the basis of the routing table of itself (the parent router 1201), a MAC address of a child router serving as the transfer destination is that of a child router assigned a prefix by itself (the parent router 1201).

The address of the network layer and the MAC address (address of the data link layer) used in these decision criteria are stored in the routing table 1105 in the parent router 1201 and the assignment management table 1109. However, illustration of the MAC address is omitted.

If the packet transfer processing unit 1104 decides to generate a routing alteration notice on the basis of the decision criteria heretofore described, the packet transfer processing unit 1104 generates a routing alteration notice containing the following contents, and passes the routing alteration notice to the routing alteration notice processing unit 1108.

A destination MAC address of a routing alteration notice message,

A destination IPv6 address of a routing alteration notice message,

A destination network address to be altered in routing,

An address of a router that becomes a next hop after routing alteration, and

A packet that triggers a notice of a routing alteration notice message

The routing alteration notice processing unit 1108 is supplied with them to generate a routing alteration notice message. The generated routing alteration notice message is transmitted to the child router 1202 via the transmission processing unit 1103.

This routing alteration notice contains the address of the parent router 1201 as the transmission source address of the data link layer, the address of the child router 1202 as the reception destination address of the data link layer, the address of the parent router 1201 as the transmission source address of the network layer, and the address of the child router 1202 as the reception destination address of the network layer. The data link layer address of the child router 1202 can be acquired from the transmission source address of the data link layer contained in a packet that has served as a trigger of transmission of the routing alteration notice. The network layer address of the child router 1202 can be acquired by conducting retrieval in the routing table 1105 and using a protocol that solves the network layer address from the data link layer address. If the address in the network layer protocol has a concept of the scope, however, an optimum scope is used.

Upon receiving this routing alteration notice, the child router 1202 inspects legality of the routing alteration notice message (step S318). Contents of the inspection are as follows:

(1) the transmission source address of the data link layer is the data link layer address of the default router;

(2) the transmission source address of the network layer is the network layer address of the default router; and

(3) the notice is a routing alteration notice for a recently transferred packet.

The default routers in the conditions (1) and (2) are default routers at time when a routing alteration notice is received. The default router is set manually by the manager, or set on the basis of information given as a notice by the server when prefix delegation has been executed. It is considered that typically a server assigned a prefix (in the present example, the parent router 1201) is set as the default router in many cases. As for the condition (3), a decision is made by referring to the packet transfer record table 1106 shown in FIG. 11.

The child router 1202 accepts only routing alteration notice satisfying the conditions (1) to (3). In the present example, the routing alteration notice processing unit 1108 in the child router 1202 accepts a routing alteration notice containing [prefix 2001:0DB8:0:5678::/64 via fe80::5678:4321]. The routing table 1105 in the child router 1202 is altered on the basis of this routing alteration notice (step S319). The routing table after the alteration is shown in FIG. 16. Similar operation is conducted for the child router 1203 as well, and the routing table is altered. The routing table after the alteration is shown in FIG. 17. Ensuing communication between the child routers 1202 and 1203 is conducted directly between them.

Ciphering processing or integrity ensuring processing may be conducted on a routing alteration notice message by using previously acquired secret information or shared information used at the time of prefix delegation execution.

The first, second and third embodiments of the present invention heretofore described can also be implemented by making a computer execute a program.

According to the embodiments of the present invention, it becomes possible to dynamically distribute network identification information and routing information without needing a dynamic routing control protocol or setting conducted by the manager. Furthermore, it is possible to prevent an unnecessary traffic from occurring in the network by suitably controlling the notice of the routing information.

What is claimed is:

1. A network connection apparatus which connects a plurality of networks to each other and conducts data transfer between the networks by using previously given routing information, the network connection apparatus comprising:
a request acceptance unit which accepts a assignment request of network identification information from a different network connection apparatus connected to the network;
an assigning unit which assigns the network identification information to the different network connection apparatus on the basis of the assignment request;
a noticing unit which notifies the different network connection apparatus of the assigned network identification information;
a generating unit which generates routing information on the basis of the assigned network identification information and host identification information of the different network connection apparatus; and
a transmitting unit which transmits the generated routing information to a further different network connection apparatus other than the different network connection apparatus, connected to at least one of the networks.

2. The network connection apparatus according to claim 1, further comprising:
a return offer reception unit which receives a return offer of the network identification information from the different network connection apparatus,
wherein
in a case where the return offer is received by the return offer reception unit, the assigning unit generates an invalidity notice which indicates that the generated routing information is invalid, and
the transmitting unit transmits the generated invalidity notice to the further different network connection apparatus.

3. The network connection apparatus according to claim 1, wherein
the assigning unit further determines a validity term of the network identification information,
in a case where the validity term of the assigned network identification information has expired, the assigning unit generates an invalidity notice which indicates that the generated routing information is invalid, and
the transmitting unit transmits the generated invalidity notice to the further different network connection apparatus.

4. The network connection apparatus according to claim 1, wherein
the noticing unit further transmits routing information based on, network identification information assigned to the further different network connection apparatus and host identification information of the further different network connection apparatus to the different network connection apparatus.

5. The network connection apparatus according to claim 1, wherein
before transmitting the generated routing information, the transmitting unit transmits a notice to the effect that new routing information is present to the further different network connection apparatus, and
upon receiving a request to the effect that the new routing information should be acquired, from the further different network connection apparatus, the transmitting unit transmits the generated routing information.

6. The network connection apparatus according to claim 1, further comprising:
a decision unit which makes a decision on the basis of previously given decision criteria whether it is permitted to transmit the generated routing information to the further different network connection apparatus,
wherein in a case where transmission is permitted by the decision unit, the transmitting unit transmits the generated routing information.

7. The network connection apparatus according to claim 1, further comprising:
a user data reception unit which receives user data from the different network connection apparatus assigned the network identification information,
wherein
the generating unit determines a transfer destination of the received user data,
in a case where the transfer destination is another network connection apparatus assigned a network identification information by the assigning unit and connected to the same network as the different network connection apparatus, the generating unit generates routing information on the basis of the network identification information assigned to the another network connection apparatus serving as the transfer destination and host identification information of the another network connection apparatus serving as the transfer destination, and
the transmitting unit transmits the generated routing information to the different network connection apparatus.

8. A program for inducing an network connection apparatus that connects a plurality of networks to each other and conducts data transfer between the networks by using previously given routing information, to execute:
accepting a assignment request of network identification information from a different network connection apparatus connected to the network;
assigning the network identification information to the different network connection apparatus on the basis of the assignment request;
notifying the different network connection apparatus of the assigned network identification information;
generating routing information on the basis of the assigned network identification information and host identification information of the different network connection apparatus; and
transmitting the generated routing information to a further different network connection apparatus other than the different network connection apparatus, connected to at least one of the networks.

9. The program according to claim 8, for inducing the network connection apparatus to further execute:
receiving a return offer of the network identification information from the different network connection apparatus;
generating an invalidity notice which indicates that the generated routing information is invalid, in a case where the return offer is received; and
transmitting the generated invalidity notice to the further different network connection.

10. The program according to claim 8, for inducing the network connection apparatus to further execute:
determining a validity term of the network identification information;
generating an invalidity notice which indicates that the generated routing information is invalid, in a case where the validity term of the assigned network identification information has expired; and
transmitting the generated invalidity notice to the further different network connection apparatus.

11. The program according to claim 8, for inducing the network connection apparatus to further execute transmitting routing information based on, network identification information assigned to the further different network connection apparatus and host identification information of the further different network connection apparatus to the different network connection apparatus together with the assigned network identification information.

12. The program according to claim 8, for inducing the network connection apparatus to further execute:
before transmitting the generated routing information, transmits a notice to the effect that new routing information is present to the further different network connection apparatus; and
upon receiving a request to the effect that the new routing information should be acquired, from the further different network connection apparatus, transmitting the generated routing information.

13. The program according to claim 8, for inducing the network connection apparatus to further execute:
making a decision on the basis of previously given decision criteria whether it is permitted to transmit the generated routing information to the further different network connection apparatus; and
in a case where transmission is permitted, transmitting the generated routing information.

14. The program according to claim 8, for inducing the network connection apparatus to further execute:
receiving user data from the different network connection apparatus assigned the network identification information;
determining a transfer destination of the received user data;
in a case where the transfer destination is another network connection apparatus assigned a network identification information and connected to the same network as the different network connection apparatus, generating routing information on the basis of the network identification information assigned to the another network connection apparatus serving as the transfer destination and host identification information of the another network connection apparatus serving as the transfer destination; and
transmitting the generated routing information to the different network connection apparatus.

15. A method of distributing routing information by a network connection apparatus that connects a plurality of networks to each other and conducts data transfer between the networks by using previously given routing information, comprising:
accepting a assignment request of network identification information from a different network connection apparatus connected to the network;
assigning the network identification information to the different network connection apparatus on the basis of the assignment request;
notifying the different network connection apparatus of the assigned network identification information;
generating routing information on the basis of the assigned network identification information and host identification information of the different network connection apparatus; and
transmitting the generated routing information to a further different network connection apparatus other than the different network connection apparatus, connected to at least one of the networks.

16. The method according to claim 15, further comprising:
receiving a return offer of the network identification information from the different network connection apparatus;
generating an invalidity notice which indicates that the generated routing information is invalid, in a case where the return offer is received; and
transmitting the generated invalidity notice to the further different network connection apparatus.

17. The method according to claim 15, further comprising:
determining a validity term of the network identification information;
generating an invalidity notice which indicates that the generated routing information is invalid, in a case where the validity term of the assigned network identification information has expired; and
transmitting the generated invalidity notice to the further different network connection apparatus.

18. The method according to claim 15, further comprising:
transmitting routing information based on, network identification information assigned to the further different network connection apparatus and host identification information of the further different network connection apparatus to the different network connection apparatus together with the assigned network identification information.

19. The method according to claim 15, further comprising:
before transmitting the generated routing information, transmits a notice to the effect that new routing information is present to the further different network connection apparatus; and
upon receiving a request to the effect that the new routing information should be acquired, from the further different network connection apparatus, transmitting the generated routing information.

20. The method according to claim 15, further comprising:
receiving user data from the different network connection apparatus assigned the network identification information;
determining a transfer destination of the received user data;
in a case where the transfer destination is another network connection apparatus assigned a network identification information and connected to the same network as the different network connection apparatus, generating routing information on the basis of the network identification information assigned to the another network connection apparatus serving as the transfer destination and host identification information of the another network connection apparatus serving as the transfer destination; and
transmitting the generated routing information to the different network connection apparatus.
